(19) United States
(12) Patent Application Publication
(10) Pub. No.: US 2020/0052772 A1
(43) Pub. Date: Feb. 13, 2020

(54) DATA TRANSMISSION METHOD AND NETWORK DEVICE

(71) Applicant: HUAWEI TECHNOLOGIES CO., LTD., Shenzhen (CN)

(72) Inventors: Tao WU, Shenzhen (CN); Teyan CHU, Shenzhen (CN)

(21) Appl. No.: 16/657,094

(22) Filed: Oct. 18, 2019

(30) Foreign Application Priority Data
Apr. 21, 2017 (CN) 201710264362.5

(51) Int. Cl. H04B 7/08; H04W 72/12; H04W 72/04

(52) U.S. Cl. CPC H04B 7/0888; H04B 7/0808; H04W 72/042; H04B 7/0825; H04W 72/121; H04B 7/0814

(57) ABSTRACT

This application provides a data transmission method and network device. The method includes: receiving first feedback information that is sent by each terminal and that includes a first antenna mode of the terminal; categorizing the at least two terminals into M groups based on the first antenna mode of each terminal; sending, by the network device, a second training frame to each terminal in each group, receiving second feedback information that is sent by each terminal in each group and that includes a second antenna mode of the terminal; regrouping, by the network device, the terminals in each group based on the second antenna mode of each terminal in the group, and determining an antenna mode of each group obtained through the regrouping; and sending, by the network device, first downlink data to each terminal based on the antenna mode of each group, where the first downlink data includes a superposition of first data of all the terminals in the group.

### CROSS-REFERENCE TO RELATED APPLICATIONS

This application is a continuation of International Application No. PCT/CN2018/081926, filed on Apr. 4, 2018, which claims priority to Chinese Patent Application No. 201710264362.5, filed on Apr. 21, 2017. The disclosures of the aforementioned applications are incorporated herein by reference in their entireties.

### TECHNICAL FIELD

This application relates to the communications field, and more specifically, to a data transmission method and network device in the communications field.

### BACKGROUND

In a high-frequency transmission technology, for example, a 35 GHz or 60 GHz high-frequency transmission technology, spatial attenuation of a high-frequency signal is higher than that of a low-frequency signal. Therefore, an antenna beamforming technology needs to be used at a transmit end and a receive end to ensure transmission quality of a signal. FIG. 1 is a schematic diagram of a beamforming technology in high-frequency transmission in the prior art.

As shown in FIG. 1, a node 1 (Node 1) needs to send data to a node 2 (Node 2). An antenna of the node 1 and an antenna of the node 2 separately transmit signals or receive signals in different directions by adjusting signal transmission or receiving directions by using a phase shifter or the like. For example, the node 1 may have n beams such as B₁, B₂, . . . , Bₙ; and the node 2 may have m beams such as U₁, U₂, . . . , Uₘ. After training, the node 1 may send data to the node 2 by using the beam B₅, and the node 2 may receive, by using the beam U₂, the data sent by the node 1 by using the beam B₅. This can ensure a highest received signal-to-noise ratio at the node 2.

However, in a high-frequency transmission technology in the prior art, the node 1 can send data only to a single user at a same moment, and the prior art fails to provide a solution that enables the node 1 to simultaneously send data to a plurality of users.

### SUMMARY

This application provides a data transmission method and network device, to enable the network device to send data to at least one terminal at a same moment, thereby achieving higher spectral efficiency.

According to a first aspect, a data transmission method is provided, including:

sending, by a network device, a first training frame to each of at least two terminals, and receiving first feedback information that is sent by each terminal and that includes a first antenna mode of the terminal, where the first antenna mode of each terminal includes a beam used when the network device sends the first training frame and a beam used when the terminal receives the first training frame;

categorizing, by the network device, the at least two terminals into M groups based on the first antenna mode of each terminal, where each of the M groups includes at least two terminals, and M is a positive integer;

sending, by the network device, a second training frame to each terminal in each group, and receiving second feedback information that is sent by each terminal in each group and that includes a second antenna mode of the terminal, where the second antenna mode of each terminal includes a beam used when the network device sends the second training frame and a beam used when the terminal receives the second training frame;

regrouping, by the network device, the terminals in each group based on the second antenna mode of each terminal in the group, and determining an antenna mode of each group obtained through the regrouping, where the antenna mode of each group includes a beam used when the network device sends downlink data to a terminal in the group and a beam used when the terminal in the group receives the downlink data; and

sending, by the network device, first downlink data to each terminal based on the antenna mode of each group, where the first downlink data includes a superposition of first data of all the terminals in the group.

In this embodiment of this application, the network device performs single-user training on the at least two terminal devices to determine the first antenna mode, groups the terminals for the first time based on the first antenna mode, performs intra-group training on the at least two terminals in each group, regroups the terminals in each group, and determines the antenna mode of each group obtained through the regrouping. In this way, the network device can send, by using a transmit mode of each group obtained through the regrouping, the first downlink data simultaneously to the terminals in the group, where the first downlink data includes data of all the terminals in the group. Therefore, in this embodiment of this application, the network device is enabled to send data to at least one terminal at a same moment, thereby achieving higher spectral efficiency.

In an implementation, the first data of each terminal in each group may not include signal power. In other words, the first data includes only original data sent by the network device to the terminal.

In an implementation, the first data of each terminal in each group includes signal power of the terminal and second data of the terminal.

The second data of each terminal may be original data sent by the network device to the terminal. The first data may be a product of the signal power of the terminal and the second data of the terminal. In this way, the network device may process, based on a signal receiving capability of the terminal, downlink data to be sent to each terminal (for example, superposing the downlink data for the terminals based on the signal power of the terminals). In this way, when a terminal receives the first downlink data that includes downlink data for a plurality of terminals, the terminal can filter out, as an interference signal, data sent by the network device to other terminals, to ultimately obtain data for the terminal.

In this embodiment of the present application, the signal power of each terminal may be determined by the network device in real time based on received signal energy that is fed back by the terminal, and then notified to the terminal. Alternatively, the signal power of each terminal may be determined by the network device and the terminal based on a value stipulated in a related standard or based on a beforehand agreement.

In an implementation, before the sending, by the network device, first downlink data to each terminal based on the antenna mode of each group, the method further includes:

sending, by the network device, first indication information to each terminal, so that each terminal receives the first downlink data based on the first indication information, where the first indication information includes an identifier of each terminal, a group identifier of a group in which each terminal is located after the second-time grouping, and the antenna mode of each group.

In an implementation, the first downlink data further includes second indication information, and the second indication information includes a group identifier of each group obtained through the regrouping. In this way, a terminal device may receive the first downlink data based on the group identifier carried in the first downlink data.

In an implementation, the categorizing, by the network device, the at least two terminals into M groups based on the first antenna mode of each terminal includes:

categorizing, into one group, terminals having a same first antenna mode; or

categorizing, into one group, terminals having a first antenna mode in which a direction of a beam used for sending the first training frame is within a first range or a direction of a beam used for receiving the first training frame is within a second range.

When the terminals are grouped for the first time, terminals having a same first antenna mode or similar first antenna modes are categorized into one group. Training frames used to train each terminal for the first time vary relatively greatly. Therefore, the first antenna mode may be not an optical antenna mode of the terminal, and terminal grouping is coarse-grained grouping.

In an implementation, the sending, by the network device, a second training frame to each terminal in each group includes:

determining an antenna mode of an i^{th} group of the M groups based on a first antenna mode of each terminal in the i^{th} group, where i is a positive integer and i≤M; and

sending a plurality of second training frames to each terminal in the i^{th} group based on the antenna mode of the i^{th} group, where the plurality of second training frames each include a group identifier of the i^{th} group, and different send training frames in the plurality of second training frames have different antenna modes.

In this embodiment of this application, a process of obtaining the second antenna mode of each terminal in each group is performed in each group, and this process may be also referred to as an intra-group training process. The first-time grouping of the terminals can be a coarse-grained grouping process. After the first-time grouping, intra-group training may be performed on each terminal in a group, to obtain the second antenna mode of each terminal. The second antenna mode is closer to the optical antenna mode than the first antenna mode.

In an implementation, the regrouping, by the network device, the terminals in each group based on the second antenna mode of each terminal in the group includes:

selecting N terminals from L terminals in each group and categorizing the N terminals into one group, where in second antenna modes of the N terminals, a direction of a beam used for sending the second training frame is within a third range or a direction of a beam used for receiving the second training frame is within a fourth range, and L and N are positive integers and N≤L.

In this way, the network device regroups, based on a result of the intra-group training, the terminals in each group obtained through the first-time grouping; and reselects N optimal terminals from L terminals, categorizes the N terminals into one group, and categorizes other terminals in the group into one group. Intra-group training has been performed on the terminals in each group obtained through the first-time grouping. Therefore, the regrouping is a fine-grained grouping process, so that first downlink data that includes downlink data for a plurality of terminals in a group obtained through the regrouping can be sent simultaneously to the plurality of terminals by using a same time-frequency resource.

According to a second aspect, a data transmission network device is provided, configured to perform the method according to the first aspect or any one of the possible implementations of the first aspect. The network device includes a module configured to perform the method according to the first aspect or any one of the possible implementations of the first aspect.

According to a third aspect, a data transmission network device is provided. The network device includes a memory, a processor, a transceiver, and a bus system. The memory and the processor are connected by using the bus system. The memory is configured to store an instruction. The processor is configured to execute the instruction stored in the memory. In addition, when the processor executes the instruction stored in the memory, the execution enables the processor to perform the method according to the first aspect or any one of the possible implementations of the first aspect.

According to a fourth aspect, an embodiment of the present application provides a computer readable medium, configured to store a computer program, where the computer program includes an instruction for performing the method according to the first aspect or any one of the possible implementations of the first aspect.

### DESCRIPTION OF DRAWINGS

FIG. 1 is a schematic diagram of a beamforming technology in the prior art;

FIG. 2 is a schematic flowchart of a data transmission method according to an embodiment of this application;

FIG. 3 is a schematic diagram of a subframe for training a terminal according to an embodiment of this application;

FIG. 4 is a schematic diagram of a beam according to an embodiment of this application;

FIG. 5 is a schematic diagram of a subframe for training a terminal according to another embodiment of this application;

FIG. 6 is a schematic diagram of a data transmission method according to another embodiment of this application;

FIG. 7 is a schematic block diagram of a data transmission network device according to an embodiment of this application; and

FIG. 8 is a schematic block diagram of a data transmission network device according to another embodiment of this application.

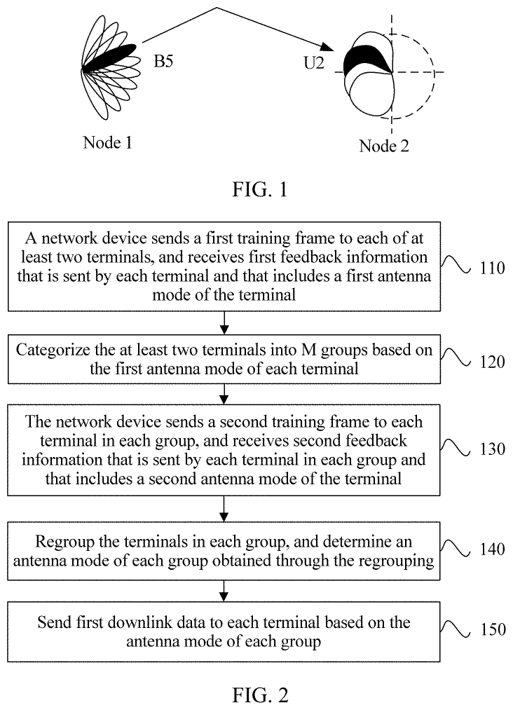

### DESCRIPTION OF EMBODIMENTS

The following describes technical solutions of this application with reference to accompanying drawings.

FIG. 2 is a schematic flowchart of a data transmission method according to an embodiment of this application. The method may be applied to a beamforming-based radio frequency system. The method is performed by a network device. The network device may be an access point (Access Point, AP) or a base station. The method includes the following operations.

110. Send a first training frame to each of at least two terminals, and receive first feedback information that is sent by each terminal and that includes a first antenna mode of the terminal, where the first antenna mode of each terminal includes a beam used when the network device sends the first training frame and a beam used when the terminal receives the first training frame. The antenna mode herein may also be referred to as an antenna beam combination or an antenna transmit mode.

In this embodiment of this application, before a plurality of users are enabled to simultaneously transmit data on a same time-frequency resource in the beamforming-based radio frequency system, group-based training needs to be performed on the plurality of users. The group-based training may be divided into three stages. The three stages are respectively a single-user training stage, a user group training stage, and a multi-user-group training stage. Herein, the users are the terminals in this embodiment of this application.

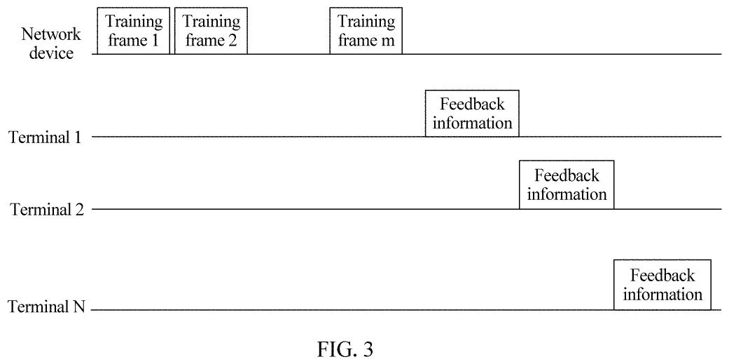

At the single-user training stage, an antenna transmit mode used when each terminal receives a training frame may be obtained by training the terminal. The training frame used at the single-user training stage may be referred to as the first training frame. FIG. 3 is a diagram of a subframe for training each terminal at this stage. Optionally, as shown in FIG. 3, obtaining a first antenna mode of each of at least two terminals may be as follows:

The network device sends a plurality of first training frames to each terminal, where each of the plurality of first training frames has a unique antenna mode.

The network device is an initiator that starts this stage of training. The network device initiates a beamforming training process by sending different training frames to each terminal. At the single-user training stage, the network device can train each terminal for the first time. In this case, antenna beams of the training frames sent by the network device may vary relatively greatly. There may be a relatively large angle between beam directions of the antenna beams of the plurality of training frames. For example, a direction of an antenna beam for sending a training frame 1 by the network device may be 5°, a direction of an antenna beam for sending a training frame 2 may be 15°, and a direction of an antenna beam for sending a training frame 3 may be 25°.

The terminal is a trained party in this embodiment of this application. When the terminal detects a plurality of training frames that have different antenna beams, the terminal uses different antenna beams to receive the plurality of training frames. In this way, for a training frame, the terminal may use a plurality of different antenna beams to receive the training frame, and may determine a highest signal-to-noise ratio for receiving the training frame. Herein, the plurality of different antenna beams used by the terminal may also vary relatively greatly. For example, there may be a relatively large angle between directions of the plurality of antenna beams. For example, the terminal may separately use antenna beams in directions of 35°, 45°, and 55° to receive the training frame 1.

When the terminal uses a plurality of different antenna beams to receive a training frame, the terminal can determine an antenna transmit mode of each training frame. When the terminal uses different antenna beams to receive a training frame, the terminal can separately determine signal quality (for example, signal-to-noise ratios) of the training frame received by using the different antenna beams, so that the terminal can determine optimal signal quality for receiving the training frame. The terminal selects best signal quality from optimal signal quality of the plurality of training frames, and determines, as an optimal antenna transmit mode of the terminal in the current training, an antenna transmit mode corresponding to a training frame of the finally selected best signal quality.

After each terminal determines an optimal antenna transmit mode of the terminal, the terminal may send information about the optimal transmit mode to the network device by using feedback information. The information about the optimal transmit mode may be, for example, a sequence number of a training frame and a direction of an antenna beam for receiving the training frame, or a direction of an antenna beam for sending a training frame and a direction of an antenna beam for receiving the training frame. The feedback information may further include information such as energy and/or a signal-to-noise ratio of a signal received by the terminal.

The network device receives the feedback information sent by each terminal; and determines, based on the feedback information sent by each terminal, an antenna transmit mode, that is, the first antenna mode, used by the terminal.

A user grouping and broadcasting stage, that is, operation 120, follows the single-user training process.

120. Categorize the at least two terminals into M groups based on the first antenna mode of each terminal, where each of the M groups includes at least one terminal, and M is a positive integer.

After first-time beamforming training on all the terminals is completed, the terminals may be grouped for the first time. During the first-time grouping, a quantity of users in a group may be greater than a final quantity of users in each group. After the first-time grouping is completed, the terminals in each group obtained through the first-time grouping may further be retrained, and regrouping is performed based on a result of the retraining. A quantity of users in each group obtained through the regrouping may be the final quantity of users in each group.

For example, when a quantity of terminals finally included in each group is 2, four terminals may be selected and categorized into one group during the first-time grouping. Then, the four terminals in the group may be retrained and regrouped, and two terminals are finally selected and categorized into one group.

When the terminals are grouped for the first time, terminals having a same first antenna mode may be categorized into one group, or terminals having similar first antenna modes may be categorized into one group.

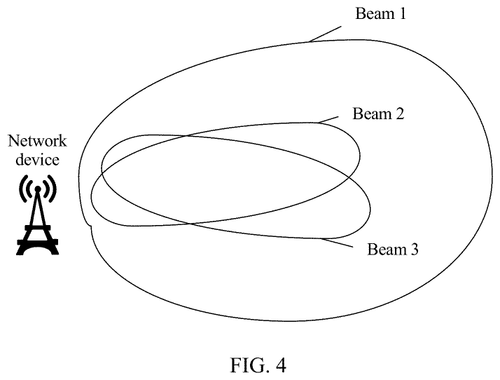

It may be considered that antenna modes, of the first antenna modes, in which a direction of a beam used for sending the first training frame is within a first range or a direction of a beam used for receiving the first training frame is within a second range are similar first antenna modes. Herein, the first range and the second range may be preconfigured, or configured based on a result of the first-time training. FIG. 4 is a schematic diagram of three possible beams according to an embodiment of this application. The three beams in FIG. 4 have similar directions. Therefore, the three beams in FIG. 4 may be considered as similar beams, and users using these three beams may be selected and categorized into one group.

For another example, the network device may determine, through training, that antenna transmit modes of a terminal 1, a terminal 2, a terminal 3, a terminal 4, a terminal 5, and a terminal 6 are respectively (B₁, U₁), (B₂, U₁), (B₂, U₁), (B₃, U₁), (B₃, U₁), and (B₄, U₄). Beam directions of B₁, B₂, B₃, and B₄ are respectively 5°, 15°, 25°, and 35°; and beam directions of U₁, U₂, U₃, and U₄ are respectively 35°, 40°, 45°, and 50°. The antenna transmit modes of the terminal 4 and the terminal 5 are the same. Therefore, the terminal 4 and the terminal 5 may be categorized into one group. Directions of first beams of the terminal 1, the terminal 2, and the terminal 3 are within a range of 5°-15°, and directions of second beams are within a range of 35°-40°. It can be seen that the antenna transmit modes of the terminal 1, the terminal 2, and the terminal 3 are similar. Therefore, the terminal 1, the terminal 2, and the terminal 3 may be categorized into one group. The antenna transmit mode of the terminal 6 varies relatively greatly from the antenna transmit modes of other terminals. Therefore, the terminal 6 may be categorized independently into one group.

130. Obtain a second antenna mode of each terminal in each group.

In this embodiment of this application, after the first-time grouping, the network device may further perform intra-group training on the terminals in each group, in other words, enter the multi-user-group training stage. The intra-group training may also be understood as performing second-time grouping on terminals in a group, and may also be referred to as second-time beamforming training. Herein, a training frame used in the intra-group training may be referred to as a second training frame.

Optionally, the network device may determine an antenna mode of an i^{th} group of the M groups based on a first antenna mode of each terminal in the i^{th} group, where i is a positive integer and i≤M.

After the terminals are grouped for the first time, the antenna mode of the i^{th} group of the M groups may be determined. Herein, the antenna mode of the i^{th} group may be used by the network device to determine a second training frame used for performing intra-group training in the i^{th} group.

For example, in the group in which the terminal 1, the terminal 2, and the terminal 3 are located, first antenna modes of the terminal 2 and the terminal 3 are the same. Therefore, (B₂, U₁) may be determined as an antenna mode of the group. Alternatively, in the antenna modes of the terminals in this group, a range of beam directions for sending the first training frame is 5°-15°, and a range of beam directions for receiving the first training frame is 35°-40°. Therefore, (10°, 37°) may be alternatively determined as the antenna mode of the group.

Herein, indication information may be further sent to each terminal, where the indication information includes an identifier of a group in which each terminal is located after the first-time grouping, an identifier of each terminal, and an antenna mode of each of the M groups. In addition, the indication information may be sent to each terminal in a multicast or broadcast manner. In this way, each terminal may determine, based on the indication information, the identifier of the group in which the terminal is located after the first-time grouping, and the antenna mode of the group in which the terminal is located.

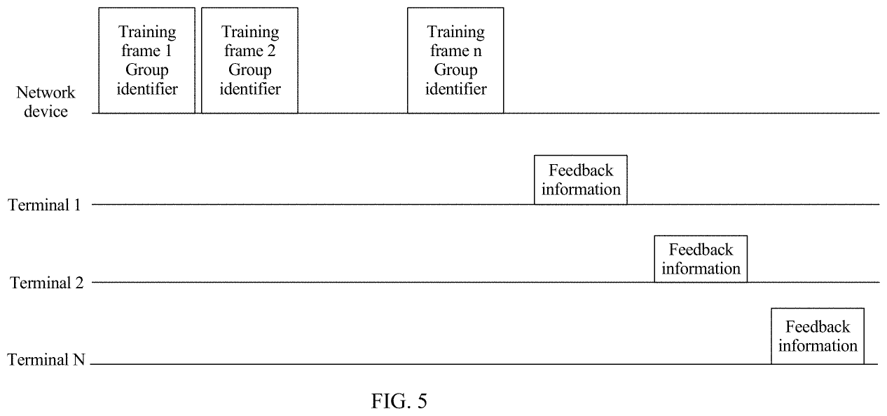

In this way, as shown in FIG. 5, the network device may send a plurality of second training frames to each terminal in the i^{th} group based on the antenna mode of the i^{th} group, where the plurality of second training frames each include a group identifier of the i^{th} group, and different send training frames in the plurality of second training frames have different antenna modes. The second-time grouping is different from the first-time grouping in which antenna modes of the plurality of second training frames sent by the network device are similar. That the antenna modes of the plurality of sent second training frames are similar may be understood as that beams for sending the plurality of second training frames are within a specific range. The specific range may be set based on the antenna mode of the i^{th} group.

For example, the antenna transmit mode of the group in which the terminal 1, the terminal 2, and the terminal 3 are located is (B₂, U₁); in other words, in the antenna mode of the group, a direction of a beam for sending downlink data is 15°, and a direction of a beam for receiving the downlink data is 35° (in this case, the antenna mode of the group may be represented as (15°,35°). In this case, a range of a beam for sending the second training frame may be 12°-18°, which specifically may separately be 12°, 13°, . . . , 17°, and 18°. For a specific training process, refer to the descriptions in operation 110. To avoid repetition, details are not described herein again.

For example, after training, a second antenna mode of the terminal 1 is (12°,35°), a second antenna mode of the terminal 2 is (15°,36°), and a second antenna mode of the terminal 3 is (16°,36°). After the terminals determine the second antenna modes, the terminals send feedback information to the network device. For details about the feedback information, refer to the descriptions in operation 110. To avoid repetition, details are not described herein again.

Then, the network device receives feedback information sent by each terminal in the i^{th} group, where the feedback information includes a second antenna mode selected by each terminal in the i^{th} group. Further, the network device may determine, based on the feedback information sent by each terminal, the second antenna mode used by each terminal in the i^{th} group. For details, refer to the descriptions of the feedback information in operation 110. To avoid repetition, details are not described herein again.

140. The network device regroups the terminals in each group based on the second antenna mode of each terminal in the group, and determines an antenna mode of each group obtained through the regrouping, where the antenna mode of each group includes a beam used when the network device sends downlink data and a beam used when each terminal receives the downlink data.

Because the training frames vary relatively greatly in the first-time beamforming training, the optimal antenna transmit mode of each terminal obtained in the process has a relatively large error. In the second-time grouping, antenna transmit modes of training frames used in a group are similar. Therefore, an optimal antenna transmit mode of each terminal may be obtained more precisely in a second-time beamforming training process, so as to group the terminals in each group for the second time based on the precise optimal antenna transmit modes.

The network device may reselect, based on feedback information sent by each terminal in a group, N optimal terminals from L users in the group (where L and N are positive integers and N≤L) and categorize the N users into one group. In second antenna modes of the N terminals, a direction of a beam used for sending the second training frame is within a third range, or a direction of a beam used for receiving the second training frame is within a fourth range. The third range and the fourth range may be configured based on a result of the intra-group training, so that the N terminals having similar antenna modes are finally categorized into one group.

In addition, the network device may further send indication information to each user, where the indication information may include a group identifier of each group obtained through the second-time grouping, an identifier of each user, and an antenna transmit mode of the group, and the indication information may further include code modulation information corresponding to each terminal and/or power information corresponding to each terminal.

For example, after the group in which the terminal 1, the terminal 2, and the terminal 3 are located is regrouped, the terminal 2 and the terminal 3 may be categorized into one group, the terminal 1 may be categorized independently into one group, and an antenna mode of each group obtained through the second-time grouping may be determined. For example, the antenna mode of the group in which the terminal 1 is located is (15°,36°), and the antenna mode of the group in which the terminal 2 and the terminal 3 are located is (15°,36°). In addition, the network device may broadcast or multicast the indication information to the terminal 1, the terminal 2, and the terminal 3, so that the terminal 1, the terminal 2, and the terminal 3 each learn of the group in which the terminal is located and the antenna mode of the group.

150. Send first downlink data to each terminal based on the antenna mode of each group, where the first downlink data includes a superposition of first data of all the terminals in the group.

The network device may send the first downlink data to all the terminals in the i^{th} group by using the antenna transmit mode of the i^{th} group, where the first downlink data may further include indication information, the indication information may be specifically a group identifier of the i^{th} group, and i is a positive integer greater than zero and less than or equal to M.

In an implementation, the first data of each terminal in each group may not include signal power. In other words, the first data includes only original data sent by the network device to the terminal.

In another possible implementation, the first data of each terminal in each group includes signal power of the terminal and second data of the terminal.

Herein, the first data of each terminal may be a product of the signal power of the terminal and the second data of the terminal. The second data may be, for example, original data that the network device needs to send to the terminal. In this way, the network device may perform, based on a signal receiving capability of the terminal, specific processing on data to be sent to each terminal (for example, superposing downlink data for the terminals based on the signal power of the terminals). In this way, when a terminal receives the first downlink data, the terminal can filter out, as an interference signal, data sent by the network device to other terminals, to ultimately obtain data for the terminal.

In this embodiment of the present application, the signal power of each terminal may be determined by the network device in real time based on received signal energy that is fed back by the terminal, and then notified to the terminal. Alternatively, the signal power of each terminal may be determined by the network device and the terminal based on a value stipulated in a related standard or based on a beforehand agreement.

For example, original data that the network device needs to send to the terminal 1 is x1, and original data to be sent to the terminal 2 is x2. The network device may determine that the first downlink data is p1x1+p2x2, where p1 and p2 are respectively signal power allocated by the network device to the terminal 1 and the terminal 2. Values of p1 and p2 may be determined by the network device based on the feedback information and notified to the terminal 1 and the terminal 2, or values of p1 and p2 may be preset by the network device based on a related standard. This embodiment of this application sets no limitation thereto.

For example, distances from the terminal 1 and the terminal 2 to a base station or an AP are different, and energy of received signals is also different. The terminal 1 is closer to the base station or the AP, and therefore energy of a received signal is high; and the terminal 2 is farther away from the base station or the AP, and therefore energy of a received signal is low. The base station or the AP may configure that p1<p2 based on this scenario. After the terminal 1 receives p1x1+p2x2, because the energy of the received signal is high, the terminal 1 may eliminate p2x2 from the received signal by using a serial interference cancellation technology, and then detect a value of x1. After the terminal 2 receives p1x1+p2x2, although the energy of the received signal is lower than that of the signal of the terminal 1, the terminal 2 may consider p1x1 as an interference signal and directly detect a value of x2 because p2>p1.

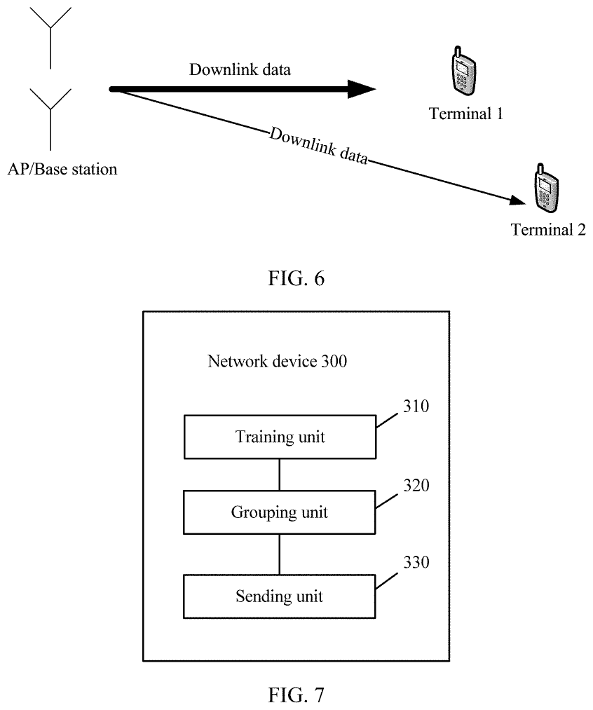

In this embodiment of this application, downlink data may be alternatively transmitted based on an antenna diversity and an antenna multiplexing technology. As shown in FIG. 6, a signal sent by an AP or a base station to a terminal 1 is

$${p}_{1} [ \begin{matrix}{x}_{1} & {x}_{2} \\ {x}_{3} & {x}_{4}\end{matrix} ] ,$$

and a signal sent to a terminal 2 is

$${p}_{2} [ \begin{matrix}{y}_{1} & {y}_{2} \\ {y}_{2}^{′} & - {y}_{1}^{′}\end{matrix} ] .$$

In this case, downlink data may be

$${p}_{1} [ \begin{matrix}{x}_{1} & {x}_{2} \\ {x}_{3} & {x}_{4}\end{matrix} ] + {p}_{2} [ \begin{matrix}{y}_{1} & {y}_{2} \\ {y}_{2}^{′} & - {y}_{1}^{′}\end{matrix} ] .$$

Because energy of a received signal of the terminal 1 is high, the downlink data may be sent to the terminal 1 in an antenna multiplexing manner. Because energy of a received signal of the terminal 2 is low, the downlink data may be sent to the terminal 2 in an antenna diversity manner.

Therefore, in this embodiment of this application, the network device performs single-user training on the at least two terminal devices to determine the first antenna mode, groups the terminals for the first time based on the first antenna mode, performs intra-group training on the at least two terminals in each group, regroups the terminals in each group, and determines the antenna mode of each group obtained through the regrouping. In this way, the network device can send, by using a transmit mode of each group obtained through the regrouping, the first downlink data simultaneously to the terminals in the group, where the first downlink data includes data of all the terminals in the group. Therefore, in this embodiment of this application, the network device is enabled to send data to at least one terminal at a same moment, thereby achieving higher spectral efficiency in this embodiment of this application.

FIG. 7 is a schematic block diagram of a data transmission network device 300 according to an embodiment of this application. The network device 300 may be an AP or a base station. The network device 300 includes:

a training unit 310, configured to send a first training frame to each of at least two terminals, and receive first feedback information that is sent by each terminal and that includes a first antenna mode of the terminal, where the first antenna mode of each terminal includes a beam used when the network device sends the first training frame and a beam used when the terminal receives the first training frame;

a grouping unit 320, configured to categorize the at least two terminals into M groups based on the first antenna mode of each terminal, where each of the M groups includes at least one terminal, and M is a positive integer, where

the training unit 310 is further configured to send a second training frame to each terminal in each group, and receive second feedback information that is sent by each terminal in each group and that includes a second antenna mode of the terminal, where the second antenna mode of each terminal includes a beam used when the network device sends the second training frame and a beam used when the terminal receives the second training frame; and

the grouping unit 320 is further configured to regroup the terminals in each group based on the second antenna mode of each terminal in the group, and determine an antenna mode of each group obtained through the regrouping, where the antenna mode of each group includes a beam used when the network device sends downlink data and a beam used when each terminal receives the downlink data; and

a sending unit 330, configured to send first downlink data to each terminal based on the antenna mode of each group, where the first downlink data includes a superposition of first data of all the terminals in the group.

In an implementation, the first data of each terminal in each group includes signal power of the terminal and second data of the terminal.

In an implementation, the sending unit 330 is further configured to:

send, first indication information to each terminal, so that each terminal receives the first downlink data based on the first indication information, where the first indication information includes an identifier of each terminal, a group identifier of a group in which each terminal is located after the second-time grouping, and the antenna mode of each group.

In an implementation, the first downlink data further includes second indication information, and the second indication information includes a group identifier of each group obtained through the regrouping.

In an implementation, the grouping unit 320 is configured to:

categorize, into one group, terminals having a same first antenna mode; or

categorize, into one group, terminals having a first antenna mode in which a direction of a beam used for sending the first training frame is within a first range or a direction of a beam used for receiving the first training frame is within a second range.

In an implementation, the training unit 310 is configured to:

determine an antenna mode of an i^{th} group of the M groups based on a first antenna mode of each terminal in the i^{th} group, where i is a positive integer and i≤M; and

send a plurality of second training frames to each terminal in the i^{th} group based on the antenna mode of the i^{th} group, where the plurality of second training frames each include a group identifier of the i^{th} group, and different send training frames in the plurality of second training frames have different antenna modes.

In an implementation, the grouping unit 320 is configured to:

select N terminals from L terminals in each group and categorize the N terminals into one group, where in second antenna modes of the N terminals, a direction of a beam used for sending the second training frame is within a third range or a direction of a beam used for receiving the second training frame is within a fourth range, and L and N are positive integers and N≤L.

Therefore, in this embodiment of this application, the network device performs single-user training on the at least two terminal devices to determine the first antenna mode, groups the terminals for the first time based on the first antenna mode, performs intra-group training on the at least two terminals in each group, regroups the terminals in each group, and determines the antenna mode of each group obtained through the regrouping. In this way, the network device can send, by using a transmit mode of each group obtained through the regrouping, the first downlink data simultaneously to the terminals in the group, where the first downlink data includes data of all the terminals in the group. Therefore, in this embodiment of this application, the network device is enabled to send data to at least one terminal at a same moment, thereby achieving higher spectral efficiency in this embodiment of this application.

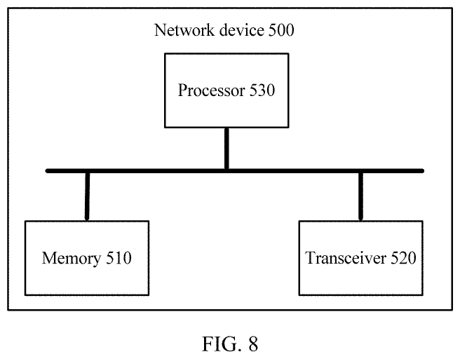

FIG. 8 is a schematic block diagram of a network device 500 according to an embodiment of this application. The network device 500 includes:

a memory 510, configured to store a program, where the program includes code;

a transceiver 520, configured to communicate with another device; and

a processor 530, configured to execute the program code in the memory 510.

Optionally, when executing the code, the processor 530 may implement the operations in the methods of FIG. 2 to FIG. 6. For brevity, details are not described herein again. In addition, the network device 500 may be an AP or a base station. The transceiver 520 is configured to transmit and receive signals while driven by the processor 530.

In this embodiment of this application, the processor 530 may be a central processing unit (CPU), or the processor 530 may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

The memory 510 may include a read-only memory and a random access memory, and provide an instruction and data to the processor 530. A part of the memory 510 may further include a non-volatile random access memory. For example, the memory 510 may further store information about a device type.

The transceiver 520 may be configured to implement signal transmission and receiving functions, for example, frequency modulation and demodulation functions, which are also referred to as up-conversion and down-conversion functions.

In an implementation process, at least one operation of the foregoing method may be completed by a hardware integrated logic circuit in the processor 530, or the integrated logic circuit may be driven by an instruction in a form of software to complete the at least one operation. Therefore, the network device 500 may be a chip or a chipset. The operations of the method disclosed with reference to the embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor 530 reads information in the memory and completes the operations in the foregoing methods in combination with hardware of the processor. To avoid repetition, details are not described herein again.

A person of ordinary skill in the art may be aware that units and algorithm operations in the examples described in combination with the embodiments disclosed in this specification may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art understands that, for the purpose of convenient and brief description, for a detailed working process of the foregoing system, apparatus, and unit, reference may be made to a corresponding process in the foregoing method embodiments, and details are not described herein again.

In the several embodiments provided in this application, a person of skill in the art understands that the disclosed system, apparatus, and method may be implemented in other manners. For example, the described apparatus embodiment is merely an example. For example, the unit division is merely logical function division and there may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the operations of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data transmission method, wherein the method comprises:
sending, by a network device, a first training frame to each of at least two terminals, and receiving first feedback information that is sent by each terminal and that comprises a first antenna mode of the terminal, wherein the first antenna mode of each terminal comprises a beam used when the network device sends the first training frame and a beam used when the terminal receives the first training frame;
categorizing, by the network device, the at least two terminals into M groups based on the first antenna mode of each terminal, wherein each of the M groups comprises at least two terminals, and M is a positive integer;
sending, by the network device, a second training frame to each terminal in each group, and receiving second feedback information that is sent by each terminal in each group and that comprises a second antenna mode of the terminal, wherein the second antenna mode of each terminal comprises a beam used when the network device sends the second training frame and a beam used when the terminal receives the second training frame;
regrouping, by the network device, the terminals in each group based on the second antenna mode of each terminal in the group, and determining an antenna mode of each group obtained through the regrouping, wherein the antenna mode of each group comprises a beam used when the network device sends downlink data to a terminal in the group and a beam used when the terminal in the group receives the downlink data; and
sending, by the network device, first downlink data to each terminal based on the antenna mode of each group, wherein the first downlink data comprises a superposition of first data of all the terminals in the group.

2. The method according to claim 1, wherein the first data of each terminal in each group comprises signal power of the terminal and second data of the terminal.

3. The method according to claim 1, before the sending, by the network device, first downlink data to each terminal based on the antenna mode of each group, further comprising:
sending, by the network device, first indication information to each terminal, so that each terminal receives the first downlink data based on the first indication information, wherein the first indication information comprises an identifier of each terminal, a group identifier of a group in which each terminal is located after the second-time grouping, and the antenna mode of each group.

4. The method according to claim 3, wherein the first downlink data further comprises second indication information, and the second indication information comprises a group identifier of each group obtained through the regrouping.

5. The method according to claim 1, wherein the categorizing, by the network device, the at least two terminals into M groups based on the first antenna mode of each terminal comprises:
categorizing, into one group, terminals having a same first antenna mode; or
categorizing, into one group, terminals having the first antenna mode in which a direction of the beam used for sending the first training frame is within a first range or a direction of the beam used for receiving the first training frame is within a second range.

6. The method according to claim 1, wherein the sending, by the network device, the second training frame to each terminal in each group comprises:
determining an antenna mode of an i^{th} group of the M groups based on a first antenna mode of each terminal in the i^{th} group, wherein i is a positive integer and i≤M; and
sending a plurality of second training frames to each terminal in the i^{th} group based on the antenna mode of the i^{th} group, wherein the plurality of second training frames each comprise a group identifier of the i^{th} group, and different send training frames in the plurality of second training frames have different antenna modes.

7. The method according to claim 1, wherein the regrouping, by the network device, the terminals in each group based on the second antenna mode of each terminal in the group comprises:
selecting N terminals from L terminals in each group and categorizing the N terminals into one group, wherein in second antenna modes of the N terminals, a direction of the beam used for sending the second training frame is within a third range or a direction of the beam used for receiving the second training frame is within a fourth range, and L and N are positive integers and N≤L.

8. A data transmission network device, wherein the network device comprises: a processor and a memory storing instructions executable by the processor such when executed, cause the network device to:
send a first training frame to each of at least two terminals, and receive first feedback information that is sent by each terminal and that comprises a first antenna mode of the terminal, wherein the first antenna mode of each terminal comprises a beam used when the network device sends the first training frame and a beam used when the terminal receives the first training frame;
categorize the at least two terminals into M groups based on the first antenna mode of each terminal, wherein each of the M groups comprises at least two terminals, and M is a positive integer, wherein
send a second training frame to each terminal in each group, and receive second feedback information that is sent by each terminal in each group and that comprises a second antenna mode of the terminal, wherein the second antenna mode of each terminal comprises a beam used when the network device sends the second training frame and a beam used when the terminal receives the second training frame; and
regroup the terminals in each group based on the second antenna mode of each terminal in the group, and determine an antenna mode of each group obtained through the regrouping, wherein the antenna mode of each group comprises a beam used when the network device sends downlink data to a terminal in the group and a beam used when the terminal in the group receives the downlink data; and
send first downlink data to each terminal based on the antenna mode of each group, wherein the first downlink data comprises a superposition of first data of all the terminals in the group.

9. The network device according to claim 8, wherein the first data of each terminal in each group comprises signal power of the terminal and second data of the terminal.

10. The network device according to claim 8, wherein when executed, cause the network device further to:
send first indication information to each terminal, so that each terminal receives the first downlink data based on the first indication information, wherein the first indication information comprises an identifier of each terminal, a group identifier of a group in which each terminal is located after the second-time grouping, and the antenna mode of each group.

11. The network device according to claim 10, wherein the first downlink data further comprises second indication information, and the second indication information comprises a group identifier of each group obtained through the regrouping.

12. The network device according to claim 8, wherein when executed, cause the network device to:
categorize, into one group, terminals having a same first antenna mode; or
categorize, into one group, terminals having a first antenna mode in which a direction of a beam used for sending the first training frame is within a first range or a direction of a beam used for receiving the first training frame is within a second range.

13. The network device according to claim 8, wherein when executed, cause the network device to:
determine an antenna mode of an i^{th} group of the M groups based on a first antenna mode of each terminal in the i^{th} group, wherein i is a positive integer and i≤M; and
send a plurality of second training frames to each terminal in the i^{th} group based on the antenna mode of the i^{th} group, wherein the plurality of second training frames each comprise a group identifier of the i^{th} group, and different send training frames in the plurality of second training frames have different antenna modes.

14. The network device according to claim 8, wherein when the instructions executed by the processor, cause the network device to:
select N terminals from L terminals in each group and categorize the N terminals into one group, wherein in second antenna modes of the N terminals, a direction of the beam used for sending the second training frame is within a third range or a direction of the beam used for receiving the second training frame is within a fourth range, and L and N are positive integers and N≤L.
